(19) United States
(12) Patent Application Publication
(10) Pub. No.: US 2015/0041497 A1
(43) Pub. Date: Feb. 12, 2015

(54) Container For Dispensing A Flowable Substance

(71) Applicant: UHU GmbH & Co., KG, Buhl (DE)

(72) Inventors: Ralf Schniedenharn, Sinzheim (DE); Simone Silvery, Walzbachtal (DE); Aurelia Liar, Achern (DE); Karl Sermersheim, Achern (DE)

(21) Appl. No.: 14/452,184

(22) Filed: Aug. 5, 2014

(30) Foreign Application Priority Data
Aug. 7, 2013 (EP) 13179578.3

(51) Int. Cl. B05B 11/04

(52) U.S. Cl. CPC B05B 11/048
USPC 222/214

(57) ABSTRACT

A container for dispensing a flowable substance, in particular glue, such as instant glue, includes a receiving body which has a circumferential wall and a main axis extending in the longitudinal direction of the receiving body. The bottom of the receiving body is formed either by a plug inserted into an open end of the receiving body or by an end wall formed integrally on the circumferential wall. A nozzle or dispensing tip for discharging the flowable substance is arranged at an end side of the receiving body facing away from the receiving body bottom. The nozzle or dispensing tip has an outlet opening. A lever is arranged on the circumferential wall and extends along the main axis forming an acute angle with the circumferential wall so that a slit-like intermediate space is formed.

### CROSS-REFERENCE TO RELATED APPLICATIONS

This application claims the priority benefit of European Patent Application No. 13 179 578.3 filed Aug. 7, 2013. The contents of which is hereby fully incorporated by reference as if set forth in its entirety herein.

### STATEMENT REGARDING FEDERALLY SPONSORED RESEARCH OR DEVELOPMENT

Not applicable.

### FIELD OF THE INVENTION

The invention relates to a container for dispensing a flowable substance, in particular glue, such as instant glue.

### BACKGROUND OF THE INVENTION

For example, a container for dispensing glues is known from WO 2007/004203 A1 and designed as a glue container. It is made of a polyolefin material, such as HDPE, and has an elongate shape along a main axis which extends in the longitudinal direction of the glue container. The glue container is formed by a circumferential wall which has a concave portion that extends along the main axis. The bottom of the container is formed by an end wall which is formed in one piece with the circumferential wall. A second end side is arranged on the end of the container facing away from the end wall and has a nozzle with an outlet opening for discharging the glue.

Containers for storing glues are problematic either with regard to their storability or their capability of adequately dispensing the glue.

To be able to store glues, such as instant glue, over a long period of time, the container often requires a correspondingly thick circumferential wall so as to avoid diffusion through the circumferential wall and permeability to water vapor to the largest possible extent. However, a thin circumferential wall is necessary for dispensing a glue of this kind precisely and with little force. When a thin circumferential wall is used, however, the above-described effects (diffusion/vapor permeability) may occur.

### SUMMARY OF THE INVENTION

Thus, it is the object of the invention to provide a container for dispensing a flowable substance which has proper storage stability and allows precisely dispensing the glue with appropriate manual force.

This object is attained in one embodiment by a container for dispensing a flowable substance, in particular glue, such as instant glue. The container according to the invention includes a receiving body which has a circumferential wall and a main axis extending in the longitudinal direction of the receiving body. The bottom of the receiving body is formed either by a plug inserted into an open end of the receiving body or by an end wall formed integrally on the circumferential wall. A nozzle or dispensing tip for discharging the flowable substance is arranged at an end side of the receiving body facing away from the receiving body bottom, said nozzle or dispensing tip having an outlet opening. The container according to the invention is characterized in that a lever is arranged on the circumferential wall, said lever extending along the main axis and forming an acute angle with the circumferential wall so that a slit-like intermediate space is formed.

The container according to the invention makes it possible to ensure the necessary and desired storage stability of the glue and also a precise dispensability of the glue with appropriate force. The storage stability can be achieved by a correspondingly thick circumferential wall and/or by appropriate material selection. The precise dispensability of the glue is achieved in that the lever is arranged on the circumferential wall, said lever being operable with appropriate force to discharge the flowable substance from the receiving body. For discharging the flowable substance, the lever is pushed in the direction of the receiving body. By operation of the lever, the circumferential wall of the receiving body is deformed in such a manner that an overpressure is generated in the receiving body and the flowable substance can be discharged from the receiving body.

In a preferred embodiment of the container according to the invention, the lever extends at least largely across the longitudinal extension of the receiving body. A container with a lever formed in this manner rests in the hand in a particularly advantageous fashion. Moreover, a lever of this kind allows compressing the receiving body at least in sections. If the lever is operated in the area of the end side, mainly the end-side area of the receiving body is compressed. If the lever is operated in the area of the receiving body bottom, the compression takes place mainly in the area of the receiving body bottom. If the lever is operated in its center area with respect to its longitudinal direction, the receiving body is substantially compressed in the center area.

In another preferred embodiment of the container according to the invention, at least one bar is arranged between the lever and the circumferential wall, said bar extending transversely to the main axis and crossing the slit-like intermediate space. A bar of this kind transmits a pressure force introduced into the lever to the receiving body in a particularly advantageous manner and leads to a higher compression of the receiving body as compared to a design without a bar when using the same force.

In another advantageous embodiment of the container according to the invention, the circumferential wall is formed tapered in the area of the bar. A circumferential wall formed in this tapered or thinner manner has the result that a pressure force introduced into the lever leads to a higher compression of the circumferential wall in the area of the bar. In consequence, this area can be pressed deeper into the receiving container and thus an appropriate or optimal amount of the flowable substance can be discharged from the receiving container in a single pressing process.

In another preferred embodiment of the container according to the invention, the lever, in its cross-section, has a progression that is convex with respect to the receiving body or curved outward with respect to the axis of the container so that a longitudinal edge of the lever, which extends along the main axis, faces away from the receiving body. The leverage effect is enhanced by such a design of the lever. The longitudinal axis of the lever is distant enough from a base area in which the lever adjoins the circumferential wall for the lever to be pressed with little force to compress the receiving container owing to the high leverage effect. Because of the convex or outward-curved progression of the lever with respect to the container axis, the lever rests well in the hand and provides a good grip for the operating fingers.

In another preferred embodiment of the container according to the invention, a lever end side, which is arranged on a side of the lever facing away from the dispensing tip, extends in a plane or flush manner with a standing surface of the plug or the end wall. An embodiment of this kind is particularly advantageous with respect to stable standing of the container. The flush arrangement of the standing surface of the receiving body bottom and the lower side of the lever leads to a secure and wobble-free standing of the container on even ground. The receiving body bottom can be formed by an end side which is formed in one piece with the receiving body and forms a standing surface, or by a pot-shaped plug which is inserted into the receiving body and whose flange or base plate forms a standing surface and is flush with the bottom-side end side of the lever. If the receiving body bottom is formed by an end side formed integrally thereon, the nozzle or dispensing tip can be pressed on at the end side of the receiving body facing away from the bottom once the flowable substance has been filled in.

In another preferred embodiment of the container according to the invention, the lever is formed as a solid body. A lever of this kind has more mass than a lever being a hollow body, which is particularly advantageous with respect to the force necessary for compressing the receiving body.

In another preferred embodiment of the container according to the invention, the receiving body is elastically deformable so that the lever is formed resiliently. An embodiment of this kind is particularly advantageous if the lever is to be pressed repeatedly. In a resilient design, the lever restores to its starting position after an operating process so as to be operated, i.e. pressed again from there.

In another preferred embodiment of the container according to the invention, the receiving body and the lever are produced together in one piece in an injection molding process. A process of this kind is particularly advantageous because it is very precise so that tolerances are not a factor and the receiving body can be formed to be highly dimensionally stable. It is also perceivable, of course, to produce the container according to the invention in an injection blow molding process or the like.

Other advantages and advantageous embodiments of the subject-matter of the invention can be taken from the description, the drawing and the claims.

### BRIEF DESCRIPTION OF THE DRAWINGS

An embodiment example of a container for dispensing a flowable substance according to the invention is illustrated in a schematically simplified manner in the drawing and will be explained in more detail in the following description. In the figures:

FIG. 1 shows a perspective view of a container according to the invention;

FIG. 2 shows a longitudinal section through the container according to FIG. 1 along a line II-II in FIG. 1;

FIG. 3 shows a cross-section through the container according to FIG. 1 along a line in FIG. 1; and

FIG. 4 shows a section through a plug according to the invention.

### DETAILED DESCRIPTION OF THE EXAMPLE EMBODIMENTS

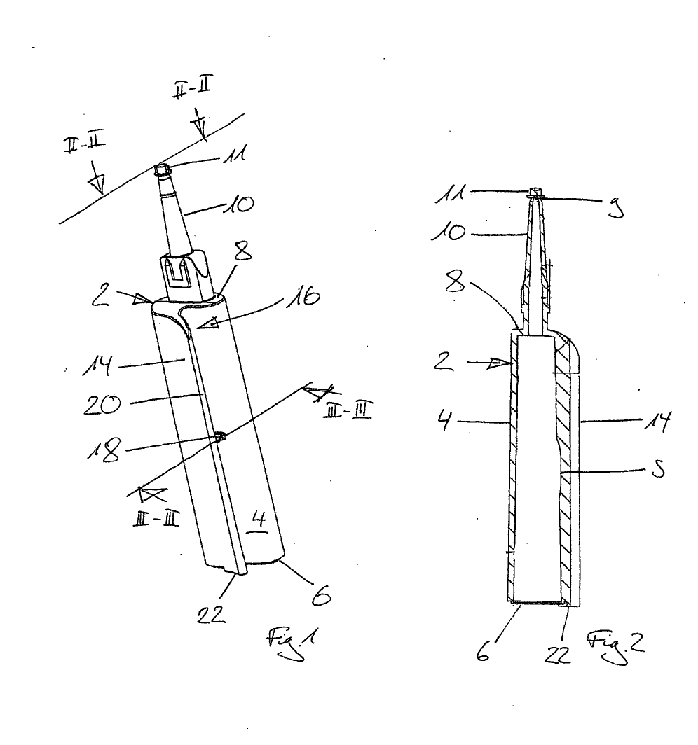

A container for dispensing a flowable substance produced in an injection molding process is illustrated in a perspective view in FIG. 1. The container comprises a receiving body 2, which has an approximately oval cross-section. The receiving body 2 extends in its longitudinal direction along a main axis of the container and has a circumferential wall 4. On a bottom-side first end side, the receiving body 2 has an open end, into which a plug 12 illustrated on its own in FIG. 4 can be inserted, which forms a receiving body bottom 6. Starting from a vertically standing position of the container, the plug 12 closes the receiving body 2 at the bottom. A dispensing tip 10 is integrally formed on a second end side 8 of the receiving body 2 facing away from the receiving body bottom 6. The dispensing tip 10 has a through-going longitudinal canal along the main axis, said canal connecting the receiving body 2 with an exterior area. At its tip, the dispensing tip 10 is provided with an original cap 11 in the embodiment illustrated in FIG. 1, said original cap 11 being formed integrally on the dispensing tip and closing an outlet opening 9 of the dispensing tip 10. For first use of the container, the original cap 11 must be separated from the dispensing tip 10 to open a discharge canal of the dispensing tip, a notch being provided in the area between the dispensing tip 10 and the original cap 11 which facilitates separating the original cap 11 from the dispensing tip 10. A closing cap (not illustrated) can be placed on the dispensing tip 10, which reversibly closes the discharge canal of the dispensing tip 10 and thus prevents a flowable substance stored in the receiving body 2 from drying out.

A lever 14 is integrally formed on a slightly curved area of the circumferential wall 4 of the receiving body 2, the circumferential wall 4 being formed approximately oval in its cross-section. The lever 14 is formed as a solid body and extends largely across the entire longitudinal extension of the receiving body 2 from the receiving body bottom 6 almost up to the second end side 8. The lever 14 forms an acute angle with the circumferential wall 4 so that a slit-like intermediate space 16 is formed. The slit-like intermediate space 16 extends from the receiving body bottom 6 in the longitudinal direction along the main axis up to the end side 8. A lever end side 22 which is located at the side of the lever 14 facing away from the second end side 8 of the receiving body is flush with a standing surface of the plug 12 which can be inserted into the open end of the receiving body 2.

At about half the height of the receiving body 2 with respect to its longitudinal extension, a bar 18 is arranged between the lever 14 and the circumferential wall 4. The bar 18 extends transversely to the main axis and crosses the slit-like space 16. The bar 18 is fixed to the lever 14 and the circumferential wall 4.

As FIG. 2 shows, the circumferential wall 4 of the receiving body 2 has a reduced thickness in the area of the bar 18 so that a tapered area 5 is formed.

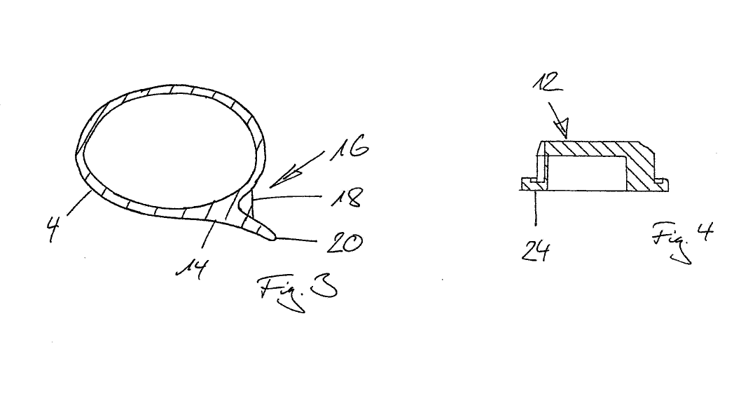

In its cross-section, the lever 14 has a convex progression with respect to the receiving body 2 or a progression curved outward with respect to the receiving body 2, as shown in FIG. 3. Owing to the fact that a longitudinal edge 20 of the lever 14, which extends along the main axis, faces away from the receiving body 2 because of the convex progression of the lever 14, a leverage effect can be achieved that allows discharging the flowable substance from the receiving body 2 with an appropriate use of force. The receiving body 2 produced in an injection molding process is designed to be elastically deformable in such a manner that the lever 14 is mounted resiliently.

The plug 12 according to FIG. 4, which can be inserted into the open end of the receiving body 2, has a pot-like shape. The plug 12 comprises a portion protruding into the receiving body 2 and a circumferential flange 24. In the position inserted into the receiving body 2, the flange 24 engages an edge of the circumferential wall 4 at the open end of the receiving body 2 and closes the receiving body 2 at the bottom side. An end side of the flange 24 of the inserted plug 12 facing away from the second end side 8 of the receiving body forms a standing surface on which the container can stand. The standing surface of the flange 24 is flush with the side of the lever facing away from the second end side 8 of the receiving body 2.

1. A container for dispensing a flowable substance, such as instant glue, said container comprising
a receiving body having a circumferential wall and defining a main axis extending in the longitudinal direction of the receiving body (2),
a receiving body bottom closing an open end of the receiving body, the receiving body bottom being formed either by a plug inserted into the open end of the receiving body or by an end wall formed integrally on the circumferential wall; and
a dispensing tip disposed at an end of the receiving body facing away from the receiving body bottom, the dispensing tip having an outlet opening for discharging the flowable substance; and
a lever extending along the main axis and forming an acute angle with the circumferential wall and defining an intermediate space between the lever and the circumferential wall.

2. The container according to claim 1, in which the lever extends substantially across the longitudinal extension of the receiving body.

3. The container according to claim 1, in which between the lever and the circumferential wall, at least one bar extends transversely to the main axis and crosses the intermediate space.

4. The container according to claim 3, in which the circumferential wall is tapered in an area proximal the bar.

5. The container according to claim 1, in which, the lever has a cross-section including a progression curved outward with respect to the receiving body so that a longitudinal edge of the lever extends along the main axis and faces away from the receiving body.

6. The container according to claim 1, in which a lever end face is arranged at a side of the lever facing away from the dispensing tip and is flush with a standing surface of the plug inserted into the receiving bottom or with the end wall.

7. The container according to claim 1, in which the lever is a solid body.

8. The container according to claim 1, in which the dispensing tip is formed integrally on the receiving body.

9. The container according to claim 1, in which the receiving body is elastically deformable so that the lever is resilient.

10. The container according to claim 1, in which the receiving body is integrally formed in one piece with the lever.
